(19) United States
(12) Patent Application Publication
(10) Pub. No.: US 2024/0262391 A1
(43) Pub. Date: Aug. 8, 2024

(54) VEHICLE PERCEPTION OF ROADSIDE SHELTERS

(71) Applicant: GM Cruise Holdings LLC, San Francisco, CA (US)

(72) Inventors: Cheuk-Hung Ng, San Francisco, CA (US); David Tran, El Granada, CA (US); Willie Lewis, San Francisco, CA (US)

(73) Assignee: GM Cruise Holdings LLC, San Francisco, CA (US)

(21) Appl. No.: 18/164,248

(22) Filed: Feb. 3, 2023

(51) Int. Cl. B60W 60/00; B60W 40/02; B60W 40/08

(52) U.S. Cl. CPC B60W 60/00253; B60W 40/02; B60W 40/08; B60W 2040/0881; B60W 2420/403; B60W 2420/408; B60W 2554/20; B60W 2555/20; B60W 2556/40; B60W 2556/45

(57) ABSTRACT

Systems and methods for vehicles to detect roadside shelters that can protect users from exposure to various weather conditions. Roadside shelter information can be mapped and added to a mapping database. Systems and methods are provided for live autonomous vehicle perception of viable shelters via machine learning. Shelter information can be incorporated into autonomous vehicle logic and decision-making for user pick-up, drop-off, delivery access, and any other user vehicle access. A user may prefer to wait for a vehicle underneath an awning or inside a bus stop shelter to avoid exposure to inclement weather. Vehicle sensors can be used for perception of roadside features.

### BACKGROUND

### 1. Technical Field

The present disclosure generally relates to vehicle perception systems and, more specifically, vehicle perception of roadside features for decreasing user weather exposure.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an autonomous vehicle having a shelter perception module, according to some examples of the present disclosure;

FIG. 2A illustrates a method for vehicle perception and identification of roadside shelters, according to some examples of the present disclosure;

FIG. 2B illustrates a method for providing a roadside shelter option to ridehail and delivery users, according to some examples of the present disclosure;

FIGS. 3A and 3B illustrate examples of perception and identification of roadside shelters, according to some examples of the present disclosure;

FIG. 4 shows an example 400 of an interface for a ridehail service, according to some examples of the present disclosure;

FIG. 5 is a diagram illustrating a fleet of autonomous vehicles in communication with a central computer, according to some embodiments of the disclosure;

FIG. 6 shows an example embodiment of a system for implementing certain aspects of the present technology; and

FIG. 7 illustrates an example of a deep learning neural network that can be used to implement a perception module and/or one or more validation modules, according to some aspects of the disclosed technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview

Systems and methods are provided for vehicles to detect roadside shelters that can protect users from exposure to various weather conditions. Additionally, roadside shelter information can be mapped and added to a mapping database. In some examples, systems and methods are provided for live autonomous vehicle perception of viable shelters via machine learning. Shelter information can be incorporated into autonomous vehicle logic and decision-making for user pick-up, drop-off, delivery access, and any other user vehicle access. For instance, a user may prefer to wait for a vehicle underneath an awning or inside a bus stop shelter to avoid exposure to inclement weather. Vehicle sensors can be used for perception of roadside features.

Autonomous vehicles can be used for ridehail services, delivery services, and other types of services. While users wait for an autonomous vehicle and when users are dropped off from an autonomous vehicle, users may be exposed to various weather conditions, including inclement weather such as rain, sleet, hail, snow, and wind, as well as sun, humidity, and heat. Additionally, users can be exposed to poor air quality such as wildfire smoke, ashy air, industrial smoke, smog, dusty air, sandy air, and so forth. In various examples, users may prefer to wait for a vehicle, access a vehicle, and/or exit a vehicle from an area that is covered, protected, or otherwise sheltered.

Systems and techniques are provided for adding perception and mapping of shelter information to an Operational Design Domain (ODD) to enable live autonomous vehicle perception of viable shelters via machine learning, and to incorporate the shelter information as part of the decision making process for user pick-up, drop-off, and other vehicle access. When a ride request, delivery request, or other vehicle access request including a pick-up/vehicle access location is received by a ridehail service, the ridehail service can identify a nearby sheltered location and suggest the nearby sheltered location to the user. In some examples, a ridehail application interface allows a user to choose whether to access the autonomous vehicle at an inputted location versus at a suggested sheltered location, when the sheltered location is different from the inputted location. In some examples, based on the live sensor-perceived information and/or sensor-perceived information plus mapped information, autonomous vehicle software can look for roadside shelters as the vehicle is approaching a pick-up, drop-off, or vehicle access location. If a roadside shelter is determined by the vehicle software to be available and accessible near the input location, the vehicle software may decide to pick up, drop off, or provide vehicle access to a user at the identified shelter. In various examples, allowing the vehicle to adjust the pick-up, drop-off, and/or vehicle access location can be based on user profile settings. If there is no determinable viable roadside shelter available nearby, the vehicle defaults to the input pick-up, drop-off, or vehicle access location. In some examples, a vehicle can be a personal autonomous vehicle, and the ridehail service discussed herein is used in conjunction with the personal autonomous vehicle. For instance, the ridehail service can be used in requesting rides (e.g., setting ride parameters) in the personal autonomous vehicle.

Vehicle sensors can be used to capture roadside features and shelter information. In particular, during vehicle perception of the environment during typical operations, the sensor suite (including LIDAR, RADAR, and cameras) can perceive roadside shelters, roofs, coverings, awnings, and other types of element blockers as the vehicle passes by. Live autonomous vehicle identification of viable shelters is implemented using machine learning. The shelter information is categorized and labeled such that the autonomous vehicle recognizes environmental features that indicate shelters. Shelter identification can be incorporated into vehicle mapping operations as well, such that, while passing by a shelter, the autonomous vehicle can associate the shelter information with the location of the vehicle. The shelter is placed within the ODD location context, and the information is stored as part of the map of a given ODD or in a database of an ODD.

Shelter utilization can be part of the autonomous vehicle decision making algorithm. In particular, as more and more shelters are perceived and identified by vehicle sensors, machine learning is applied to the different identified shelters. Machine learning is used to enable the autonomous vehicle software to learn and understand the types of shelters that are available and also which shelters are viable as stopping locations for user pick up, drop off, and/or access. This allows the autonomous vehicle software to perceive shelters and without relying on an existing database or map, even if a database or map can be used as a cross reference or secondary check. Thus, although roadside shelter type and location information is obtained and stored in a mapping system and/or mapping database, vehicle sensors are also able to perceive roadside shelters in real time as a vehicle drives down the road. The vehicle can identify new shelters such as unmapped shelters and/or temporary shelters. Additionally, a vehicle can perceive the lack of shelter where there is expected to be a shelter by comparing live perceived information with mapped information.

### Example Vehicle for Shelter Perception and Identification

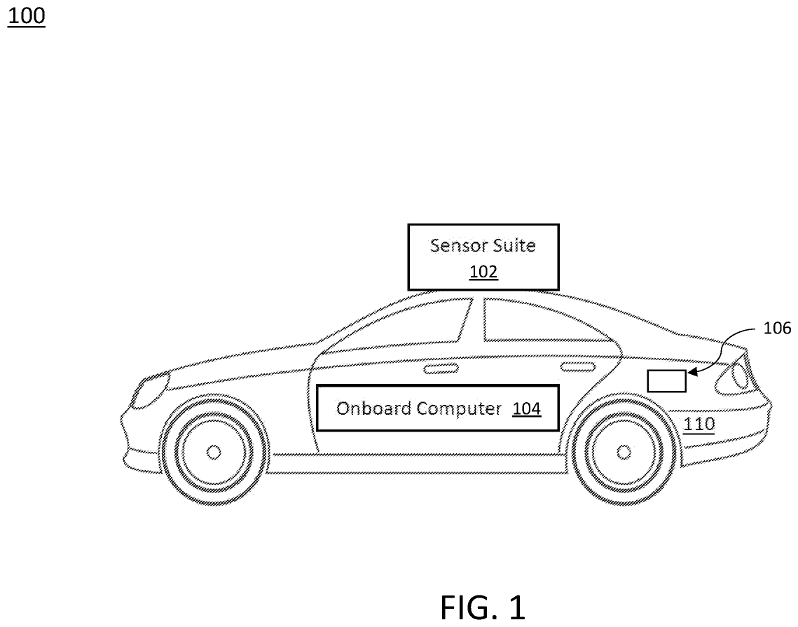

FIG. 1 illustrates an autonomous vehicle 110 having a shelter perception module 106 that perceives and identifies roadside shelters, according to some examples of the present disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. In some examples, the autonomous vehicle 110 is a personal autonomous vehicle that is used by one or more owners for driving to selected destinations. In some examples, the autonomous vehicle 110 can connect with a central computer to download vehicle updates, maps, and other vehicle data. The shelter perception module 106 uses vehicle sensor data, such as data from the sensor suite 102, as well as other imaging and/or sensor data, to perceive vehicle surroundings and environmental features as described herein.

The sensor suite 102 includes localization and driving sensors. For example, the sensor suite 102 may include one or more of photodetectors, cameras, RADAR, sound navigation and ranging (SONAR), LIDAR, Global Positioning System (GPS), inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment. In particular, the sensor suite 102 can be used to identify information and determine various factors regarding an autonomous vehicle's environment. In some examples, data from the sensor suite 102 can be used to update a map with information used to develop layers with waypoints identifying various detected items, such as locations of roadside shelters. Additionally, sensor suite 102 data can provide localized traffic information, ongoing road work information, and current road condition information. Furthermore, sensor suite 102 data can provide current environmental information, including current roadside environment information, such as the presence of people, crowds, and/or objects on a roadside or sidewalk. In this way, sensor suite 102 data from many autonomous vehicles can continually provide feedback to the mapping system and a high fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. Additionally, the onboard computer 104 processes data for the shelter perception module 106, and can use sensor suite 102 data for identifying various roadside shelters. In some examples, the onboard computer 104 checks for vehicle updates from a central computer or other secure access point. In some examples, a vehicle sensor log receives and stores processed sensed sensor suite 102 data from the onboard computer 104. In some examples, a vehicle sensor log receives sensor suite 102 data from the sensor suite 102. In some examples, the shelter perception module 106 accesses the vehicle sensor log. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passengers inside the vehicle. Additionally, based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, a bicycle, a scooter, a tractor, a lawn mower, a commercial vehicle, an airport vehicle, or a utility vehicle. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

### Example Method for Perception and Identification of Roadside Shelters

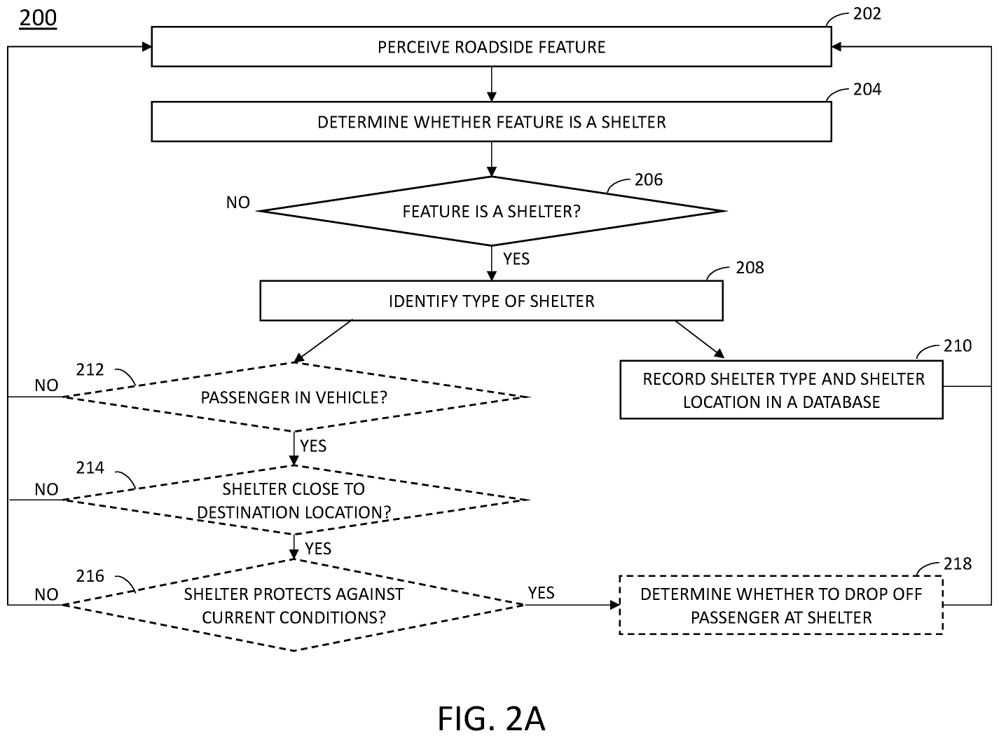

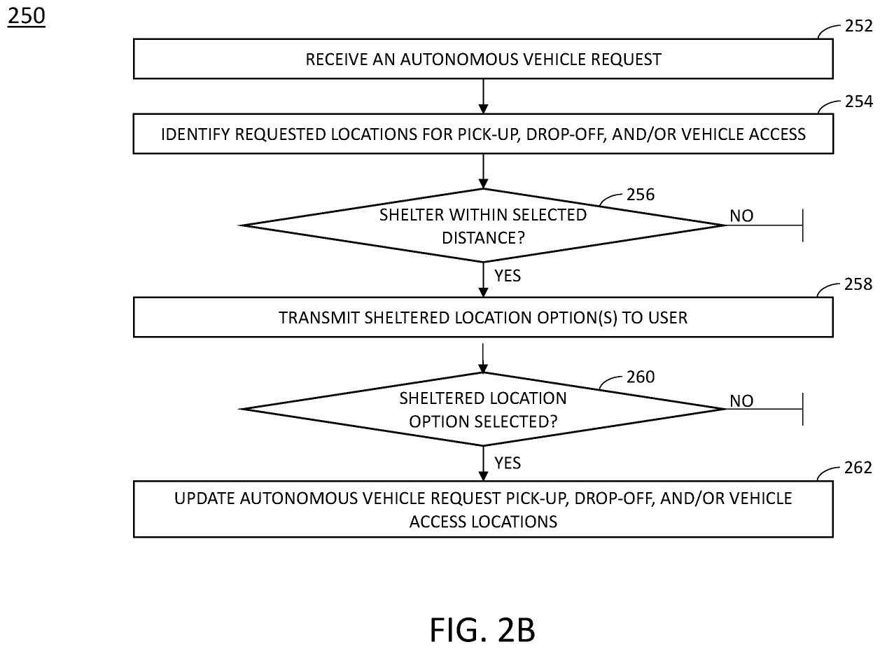

FIG. 2A is a flow chart illustrating an example of a method 200 for vehicle perception and identification of roadside shelters, according to some examples of the present disclosure. At step 202, the vehicle perceives a roadside feature. In particular, vehicle sensors detect the local environment around the vehicle, and a shelter perception module identifies features that may correspond to a roadside shelter. In various examples, the vehicle sensors include imaging sensors, cameras, LIDAR sensors, and RADAR sensors.

At step 204, the shelter perception module determines whether the roadside feature represents a shelter. The shelter perception module can include a machine learning module. In some examples, the machine learning module can compare the roadside feature to features of known shelters and determine whether the feature is a shelter. At step 206, the shelter perception module determines whether the perceived roadside feature is a shelter. If the shelter perception module determines the perceived roadside feature is not a shelter, the method 200 ends and returns to step 202.

If the shelter perception module determines the perceived roadside feature is a shelter, the method 200 proceeds to step 208, and the shelter perception module identifies the type of shelter. In particular, in some examples, the shelter can protect a user from the elements just from one direction (e.g., an overhead shelter), or from multiple directions (e.g., a partially enclosed or fully enclosed shelter). Additionally, the shelter can provide protection from certain types of weather or other potential exposures. The shelter can be a natural shelter, a man-made shelter, or any other type of shelter. The machine learning module can identify the shelter along with various categorizations for the shelter, such as type of protection the shelter provides, amount of enclosure the shelter provides, direction of the opening of the enclosure, size of the shelter, and proximity of the shelter to the curb. The size of the shelter can include the width of the enclosed space, the depth of the enclosed space, the height of the enclosed space, and/or the area of the enclosed space. Various types of shelters include a roof, a covering, an awning, a bus shelter, a lobby, a bridge, a highway overpass, a tree, a cave, and a cliff. The shelter provides some amount of protection against various elements, and the types of elements and/or weather that the shelter can provide protection against can also be identified by the machine learning module. The elements can include inclement weather such as rain, hail, snow, sleet, and wind. Additionally, the shelter can provide protection from the sun and/or from outdoor heat. In other examples, the shelter can provide protection from poor air quality, such as protection from dusty, smoggy, sandy, and/or ashy conditions, which, for instance, may potentially be encountered in high smog cities, in desert locations, or during wildfire season.

At step 210, the shelter perception module saves the shelter in a database, wherein the database entry for the shelter can include the shelter type, one or more shelter categorizations, shelter size, proximity of the shelter to the curb and/or vehicle access location, shelter location, and the types of elements and/or weather the shelter can provide protection from. As described in greater detail below, the database can be used to suggest shelter locations for passenger pick-up, passenger drop-off, and other user vehicle access. In various implementations, the database can be used by any vehicle in a fleet of vehicles, and the database can be used by a ridehail service to suggest sheltered locations for passenger pick-up, passenger drop-off, and other user vehicle access when a ride or delivery request is received. In some examples, the database can be used by personal autonomous vehicles to suggest sheltered locations for passenger pick-up, passenger drop-off, and other user vehicle access when a ride or delivery request is received. In some examples, a personal autonomous vehicle may connect to an autonomous vehicle cloud service similar to a ridehail service but with one or more personal autonomous vehicles associated with each user account for providing rides (and/or deliveries) to the user(s).

Following step 208, the method 200 may optionally proceed to step 212, and determine whether there is a passenger in the vehicle. If no passenger is in the vehicle, the method 200 returns to step 202. If there is a passenger in the vehicle, at step 214, it is determined whether the shelter is close to the destination location. In some examples, to determine whether the shelter is close to the destination location, the vehicle determines whether the shelter is within a selected distance of the destination location, where the selected distance can be ten feet, twenty feet, fifty feet, or less than fifty feet. In some examples, the passenger ridehail account includes a selection indicating how close the shelter should be to a drop-off location (i.e., the selected distance) to suggest the shelter as a potential drop-off location. Similarly, for personal autonomous vehicles, an autonomous vehicle user account includes a selection indicating how close the shelter should be to a drop-off location (i.e., the selected distance) to suggest the shelter as a potential drop-off location. If the shelter is not close to the destination location (i.e., if the distance between the shelter and the destination location is greater than the selected distance), the method 200 returns to step 202.

If the shelter is within the selected distance to the destination location, at step 216, the vehicle determines whether the shelter provides protection against current conditions. In particular, if current conditions include precipitation such as rain, sleet, hail, or snow, and the shelter provides overhead protection, it can be determined that the shelter provides protection against current conditions. If the current conditions include smoky and/or ashy air (e.g., from a wildfire), and the shelter provides only overhead protection, it can be determined that the shelter does not provide protection against current conditions. In another example, if the shelter is made of transparent materials and not fully enclosed, and current conditions are sunny and hot, it can be determined that the shelter does not provide protection against current conditions. If the shelter does not provide protection against current conditions, the method 200 returns to step 202.

If the shelter does provide protection against current conditions, the method proceeds to step 218, and it is determined whether to drop off the passenger at the shelter. In some examples, the passenger is asked whether they would like to be dropped off at the shelter location instead of the destination location. For instance, an audio and/or video message can be played and/or displayed inside the vehicle, via vehicle speakers, passenger headphones (if connected to the vehicle, e.g., via Bluetooth), and/or vehicle screens, asking if the passenger would prefer to be dropped off at the shelter. In some examples, the message can be sent to the passenger's mobile device, via a ridehail application and/or via a text message. If the passenger responds with a request to be dropped off at the shelter, the vehicle can pull over close to the shelter to allow the passenger to exit the vehicle. If the passenger does not respond, or rejects the suggested shelter location for drop off, the vehicle continues to the destination location.

The method 200 can be repeated as a vehicle is driving, such that the shelter perception module can perceive any roadside feature the vehicle passes that may be a potential shelter. In various examples, the shelter perception module can perceive a shelter location that is in front of (or behind) the vehicle. In some examples, the vehicle can access a database of shelters, where the database includes shelters previously detected by other vehicles. In some examples, vehicle mapping information includes shelter locations, as previously perceived and identified by other vehicles.

In various implementations, the method 200 can be used to add perception and mapping of roadside shelter information in a given ODD, to enable live autonomous vehicle perception of viable shelters via machine learning, and to incorporate shelter information into the autonomous vehicle user pick-up, drop-off, and access logic and decision making, especially during inclement weather operations. To accomplish this, existing and planned sensors can be utilized to capture roadside features and shelter information, and shelter utilization can be part of the autonomous vehicle decision making algorithm. In various examples, the shelters are roadside, on the sidewalk, or otherwise very close to an available user access, pick-up, and/or drop-off location.

In some implementations, before dropping off a passenger, the shelter perception module, or another vehicle perception module, evaluates a potential drop-off area for factors other than shelter. For example, the vehicle can scan the area and determine whether it is well-lit, whether the space is free of people (or free of crowds), and whether there is actually shelter available at the time of drop-off. For instance, lighting can be evaluated using vehicle image sensors, and can include lighting of the entire shelter area and/or lighting of a portion of the shelter area. In some examples, a shelter can be crowded with no space available for an additional person, or a shelter can be temporary and no longer be available at drop off (e.g., an awning can be removed). In some examples, vehicle microphones can be used to detect a rowdy crowd, a noisy crowd, loud noises, or noises recognizable from a situation a user prefers to avoid. Another factor that can be considered is cleanliness of the shelter, including the presence of debris, dirt, trash, mud, rubble, grime, waste, and/or general filth. In some examples, the shelter perception module can determine cleanliness. In some examples, a user can rank and/or rate various shelter factors.

Another factor that can be considered is the time of day. For example, the shade patterns of buildings in the city change with the seasons, which can be considered if a user prefers a shady area to avoid direct sunlight. In other examples, some users may prefer to avoid certain areas at night or in the dark. Other environmental considerations can also affect whether a sheltered area is a suitable drop-off location. For example, an overpass may provide protection from the elements, but it is generally not an area most passengers want to be dropped off. In some examples, a user can elect not to be dropped off at a shelter after seeing and evaluating the shelter themselves.

In various implementations, as the shelter perception module is developed, perception, labeling, and categorization of roadside shelters is performed and entered into a map and/or a mapping database for use by future passengers and users. In some examples, initial labeling and categorization can be performed by trained personnel. In some examples, the machine learning module saves an image in addition to the shelter location, type, categories, and other shelter classifications, and a live person can check the machine learning module's determination of the shelter type, categories, and other shelter categorizations against the image of the shelter. In some examples, user feedback can be considered in updating the machine learning model. In some examples, a ridehail application can provide incentives for user feedback. Similarly, for a personal autonomous vehicle, a vehicle application can provide incentives for user feedback. User feedback can include ratings, and a shelter location can be rated for various features such as protection from weather, comfort, accessibility, environment, cleanliness, lighting, etc. In some examples, an average user rating can be included with each shelter in a shelter database, where the average user rating can be a scaled score such as “5 stars”, “4 stars”, and so on.

### Example Method for Roadside Shelter Vehicle Access

FIG. 2B is a flow chart illustrating an example of a method 250 for providing a roadside shelter stop option to ridehail and delivery users, as well as personal autonomous vehicle users, according to some examples of the present disclosure. At step 252, an autonomous vehicle ridehail and/or delivery request is received. The request includes a pick-up location and a drop-off location for a passenger and/or an item. In various examples, the request is received at a ridehail service. In some examples, the request is received at a personal autonomous vehicle cloud service. In some examples, the ridehail service is a service for an autonomous vehicle owner to order rides from their own personal autonomous vehicle. At step 254, the requested locations for pick-up, drop-off, and/or vehicle access are identified. At step 256, it is determined whether there is a roadside shelter close to any of the identified locations. In some examples, the ridehail service searches a shelter database for shelters that are located within a selected distance of the identified locations. If no shelters are found at step 256, the method 250 ends.

If, at step 256, one or more shelters are identified that are located within a selected distance of any of the request locations, the method proceeds to step 258. At step 258, the sheltered location option(s) are transmitted to the user. In particular, in some examples, the ridehail application through which the user submitted the ride request can display a prompt asking the user whether the user would prefer to be picked up, dropped off, or otherwise access the vehicle at a nearby roadside shelter. The prompt can include the shelter location on a map, as well as the nearby input location. In some examples, the prompt can include multiple sheltered location options, and the multiple sheltered location options, as well as the nearby input location, can all be shown on a map. In some examples, the ridehail application displays one prompt for each entered location for which a nearby shelter is identified. For example, when a ride request is received, the ridehail application can show a first prompt for one or more alternative (sheltered) pick-up locations, and a second prompt for one or more alternative (sheltered) drop-off locations. In various examples, the ridehail application can be an autonomous vehicle application associated with a personal autonomous vehicle.

At step 260, it is determined whether a sheltered location option is selected by the user. In particular, for a ride request, it is determined whether a sheltered location option is selected by the user for the pick-up location, the drop-off location, or both the pick-up location and the drop-off location. Similarly, for a delivery request, it is determined whether a sheltered location option is selected by the user for vehicle access for delivery pick-up and/or for vehicle access for delivery drop-off. If no sheltered location options were selected, the method ends. Similarly, if the user does not respond to any of the prompts at step 258, the vehicle will default to the exact locations input by the user for pick-up, drop-off, and/or vehicle access in the request.

If a sheltered location option is selected by the user, at step 262, the autonomous vehicle request is updated accordingly. In particular, if a sheltered location option is selected for the pick-up location, the pick-up location is updated to the selected sheltered location. Similarly, if a sheltered location option is selected for the drop-off location, the drop-off location is updated to the selected sheltered location. If a sheltered location option is selected for a vehicle access location for an autonomous vehicle delivery request, the vehicle access location is updated to the selected sheltered location.

In some examples, a rideshare application can include an option in a user profile that can create a default location preference. In particular, an optional user profile setting may allow the user to set a preference in the rideshare application or user profile for loading/unloading at a shelter versus loading/unloading closer to the user-input location. In some examples, the setting can be specific to specific conditions, such as inclement weather, sun with heat, and/or poor air quality. In some examples, a user profile can include a preference to adjust the pick-up and/or drop-off location to a shelter location that is within a selected distance of the input pick-up and/or drop-off location. In some examples, the selected distance can be measured as either physical distance (in feet, meters, or other units), or as time in seconds of walking to reach the input pick-up and/or drop-off location.

In some examples, another vehicle can be a shelter location. For instance, if a user requests a ride to the user's vehicle, the user's vehicle is a shelter location. Similarly, another autonomous vehicle that is not being used can be a shelter location. For instance, a vehicle at a charging station can be used as a shelter location. Similarly, if a user switches vehicles during a trip (e.g., a long distance trip), the first vehicle can provide a shelter while a user waits for a second vehicle.

### Example Diagrams of Vehicle Perception and Identification of Roadside Shelters

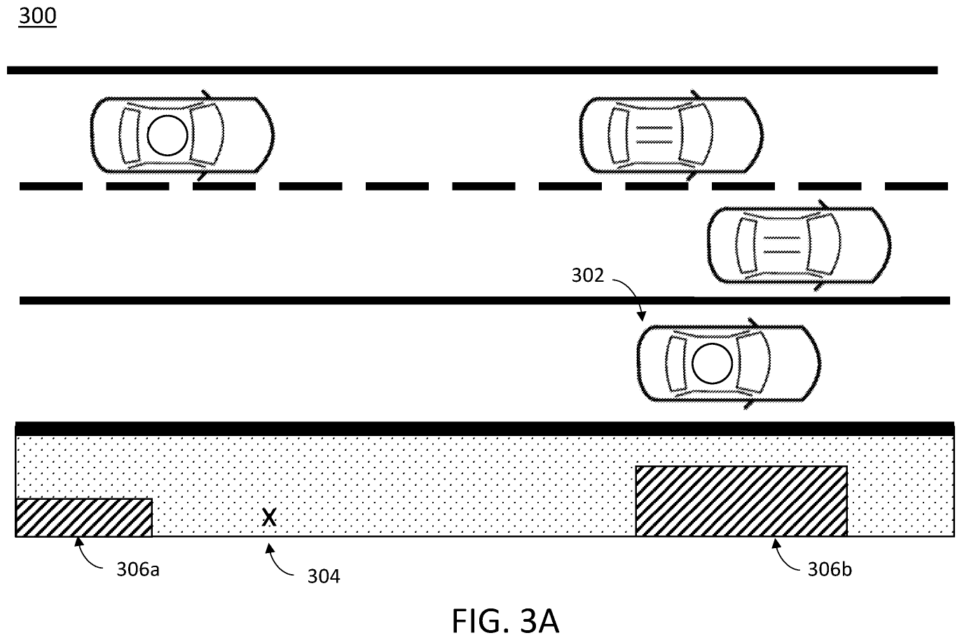

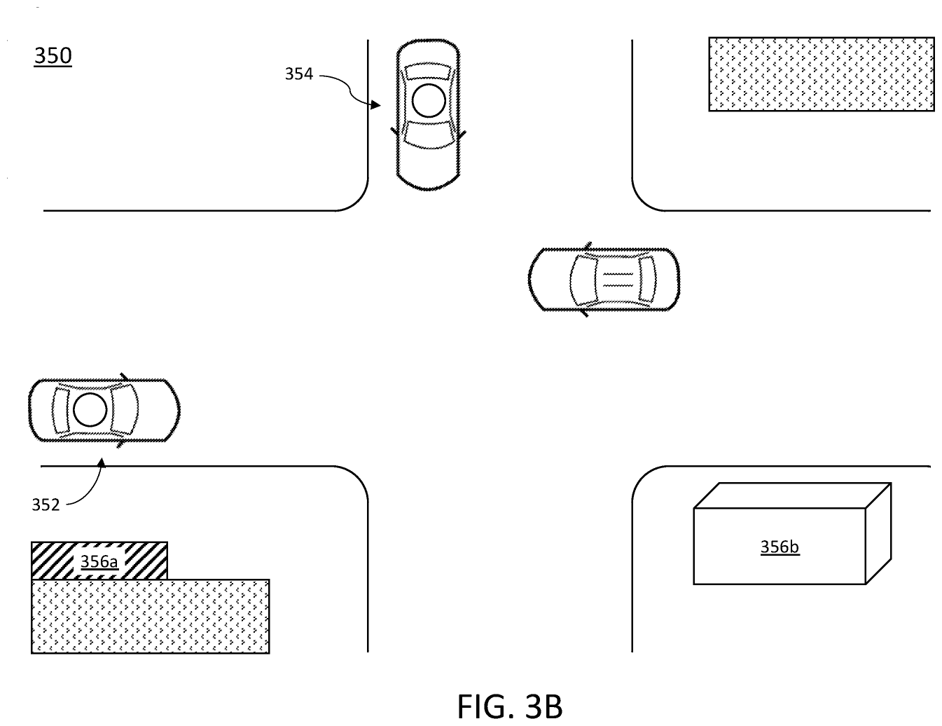

FIGS. 3A and 3B are block diagrams illustrating examples of perception and identification of roadside shelters, according to some examples of the present disclosure. In particular, FIG. 3A is a diagram 300 illustrating a vehicle 302 stopped at a roadside shelter 306b. In some examples, a ride request includes a pick-up, drop-off, or vehicle access location at the input location “x” 304, and the vehicle 302 stops instead at the shelter location 306b.

For instance, in one example, a ride request includes a pick-up location at the input location “x” 304, the ridehail application identifies nearby first 306a and second 306b shelter locations from a shelter database. The ridehail application presents the first 306a and second 306b shelter locations to the user and prompts the user as to whether the user would prefer to be picked up at one of the first 306a and second 306b shelter locations instead of the input location “x” 304. The user may select the second shelter location 306b because the shelter is larger and offers more protection than the first shelter location 306a.

In another example, a ride request includes a drop-off location at the input location “x” 304, and as the vehicle 302 nears the drop-off location, the vehicle shelter perception module identifies the first 306a and second 306b shelter locations. The vehicle then prompts the passenger as to whether the passenger would prefer to be dropped off at one of the first 306a and second 306b shelter locations instead of the input location “x” 304. For example, the alternative drop-off locations can be displayed on an in-vehicle display or tablet, can be played over in-vehicle speakers, and can be transmitted to a passenger mobile device. In some examples, the vehicle 302 consulted a mapping database (or a shelter database) and expected the first 306a and second 306b shelters to be present. In other examples, one or both of the first 306a and second 306b shelters may be new, and not present in the database.

FIG. 3B is a diagram 350 illustrating two autonomous vehicles 352, 354 having shelter perception modules and perceiving first 356a and second 356b roadside shelters, according to some examples of the present disclosure. In particular, as the vehicles 352, 354 are driving, the shelter perception modules scan roadside features and identify shelters. In some examples, the shelter perception modules identify the first roadside shelter 356a as an overhead shelter, which can provide some protection from precipitation and from sun. Similarly, the shelter perception modules identify the second roadside shelter 356b as a partially enclosed shelter that provides good protection from various conditions and includes one or more benches for a user to sit on while waiting. In some examples, the second roadside shelter 356b is a bus stop shelter. The shelter perception modules in the vehicles 352, 354 can transmit the shelter information to be saved in a mapping database for use by a ridehail service and by other vehicles. According to various examples, the vehicles 352, 354 are not stopping at or close by either of the shelters 356a, 356b, but the shelter perception modules continue to scan the roadside and save shelter information for future use.

### Example Interface for Roadside Shelter Location Selection

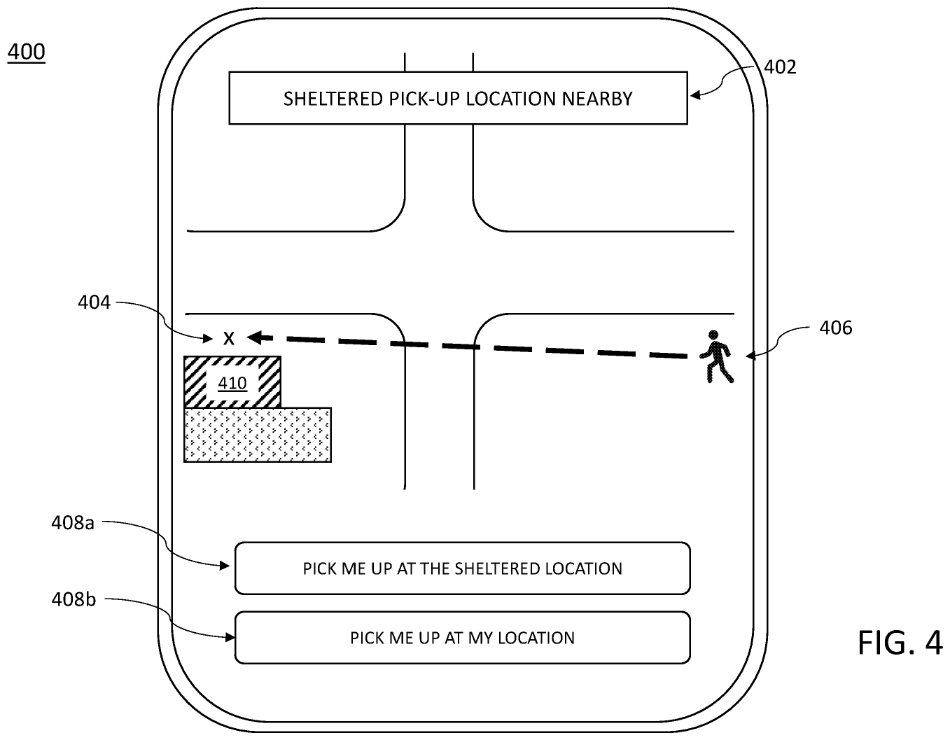

FIG. 4 shows an example 400 of an interface for a ridehail service, according to some examples of the present disclosure. In particular, FIG. 4 shows a prompt 402 that can be displayed after a user enters a ride request including a pick-up location. The prompt 402 alerts the user that a sheltered pick-up location 404 is available nearby. The interface displays a map including the input pick-up location 406, as well as a sheltered location 404. In particular, the sheltered location 404 is located under a shelter 410. The structure 410 provides the user with a sense of the size of the structure. In some examples, when a user selects the structure 410, a pop-up box appears providing shelter 410 details, such as shelter size, enclosure type, presence of seating, and average user rating. The user can select between two buttons at the bottom of the interface: a first button 408a electing to be picked up at the sheltered location 404, and a second button 408b electing to be picked up at the input location 406. In some examples, when a user hovers over the first button 408a, the sheltered location 404 is highlighted. Similarly, in some examples, when a user hovers over the second button 408b, the input location 406 is highlighted. In some examples, the interface can be closed out or ignored, and then the input location 406 will be used as the pick-up location.

### Example of an Autonomous Vehicle Fleet

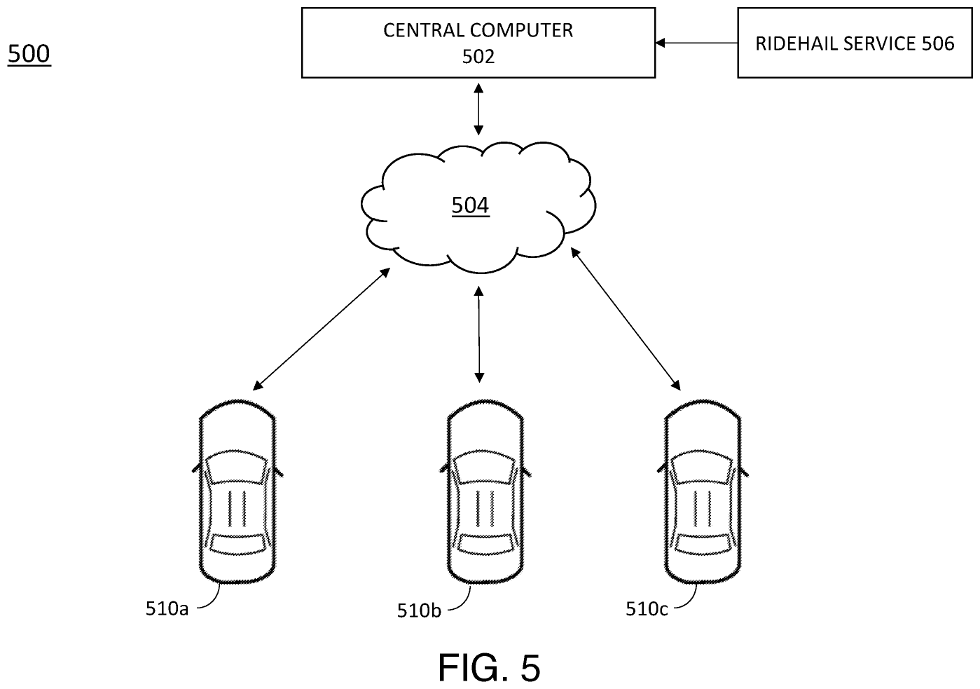

FIG. 5 is a diagram 500 illustrating a fleet of autonomous vehicles 510a, 510b, 510c in communication with a central computer 502, according to some embodiments of the disclosure. The vehicles 510a-510c communicate wirelessly with a cloud 504 and a central computer 502. The central computer 502 includes a routing coordinator and a database of information from the vehicles 510a-510c in the fleet. The database of information can include roadside shelter information as discussed herein. Autonomous vehicle fleet routing refers to the routing of multiple vehicles in a fleet. The central computer also acts as a centralized ride management system and communicates with ridehail users via a ridehail service 506. In various examples, the ridehail service 506 includes a rideshare service (and rideshare users) as well as an autonomous vehicle delivery service. Via the ridehail service 506, the central computer receives ride requests from various user ridehail applications. In some implementations, the ride requests include a pick-up location, a drop-off location, and/or a stopping location. In some implementations, a delivery request includes vehicle access locations for delivery pick-up and for delivery drop-off. In some implementations, the autonomous vehicles 510a-510c communicate directly with each other.

When a ride request is entered at a ridehail service 506, the ridehail service 506 sends the request to the central computer 502. In some examples, during a selected period of time before the ride begins, the vehicle to fulfill the request is selected and route for the vehicle is generated by the routing coordinator. In other examples, the vehicle to fulfill the request is selected and the route for the vehicle is generated by the onboard computer on the autonomous vehicle. In various examples, information pertaining to the ride is transmitted to the selected vehicle 510a-510c. With shared rides, the route for the vehicle can depend on other passenger pick-up and drop-off locations. Each of the autonomous vehicles 510a, 510b, 510c in the fleet includes a shelter perception module for detecting roadside shelters as described herein. The vehicles 510a, 510b, 510c communicate with the central computer 502 via the cloud 504.

As described above, each vehicle 510a-510c in the fleet of vehicles communicates with a routing coordinator. Thus, information gathered by various autonomous vehicles 510a-510c in the fleet can be saved and used to generate information for future routing determinations. For example, sensor data can be used to generate route determination parameters. In general, the information collected from the vehicles in the fleet can be used for route generation or to modify existing routes. For example, information regarding roadside shelters can be used to suggest sheltered locations for vehicle pick-up, drop-off, and/or other vehicle access. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more traveling preferences and/or routing goals. In some examples, the routing coordinator uses collected position data corresponding to emergency events to generate a best route for an autonomous vehicle to avoid a potential emergency situation and associated unknowns.

According to various implementations, a set of parameters can be established that determine which metrics are considered (and to what extent) in determining routes or route modifications. For example, expected congestion or traffic based on a known event can be considered. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, safety of the route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints. Routing goals can also be considered in suggesting sheltered stop locations. For instance, it may be beneficial for routing purposes to stop around the corner from an input location, and a roadside shelter may also be present at the more beneficial location.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridehailing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, ridehail revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals takes priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination. In some implementations, the routing coordinator in the central computer 502 generates a route for each selected autonomous vehicle 510a-510c, and the routing coordinator determines a route for the autonomous vehicle 510a-510c to travel from the autonomous vehicle's current location to a first destination.

### Example of a Computing System for a Shelter Perception Module

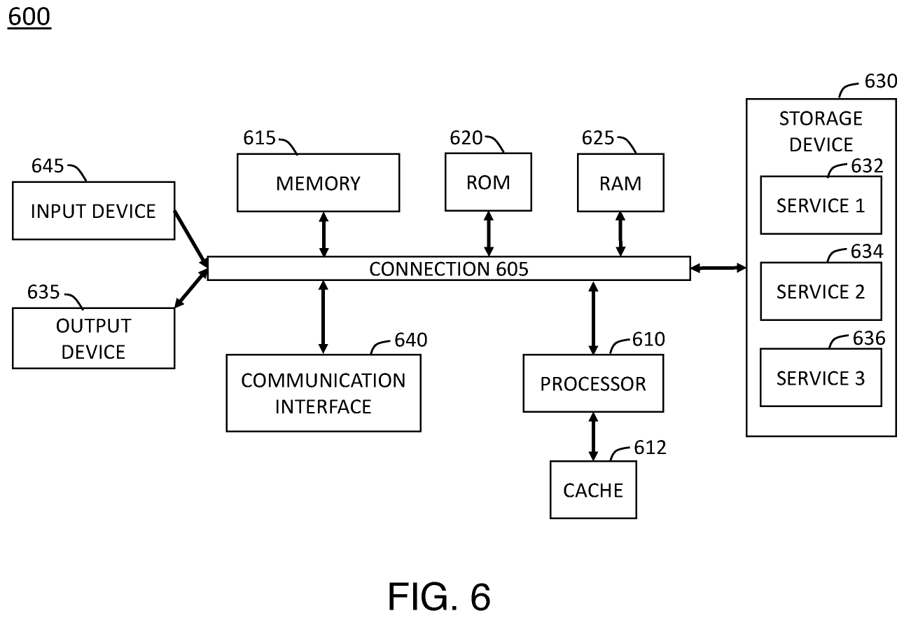

FIG. 6 shows an example embodiment of a computing system 600 for implementing certain aspects of the present technology. In various examples, the computing system 600 can be any computing device making up the onboard computer 104, the central computer 502, or any other computing system described herein. The computing system 600 can include any component of a computing system described herein which the components of the system are in communication with each other using connection 605. The connection 605 can be a physical connection via a bus, or a direct connection into processor 610, such as in a chipset architecture. The connection 605 can also be a virtual connection, networked connection, or logical connection.

In some implementations, the computing system 600 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices. For example, the components can include a simulation system, an artificial intelligence system, a machine learning system, and/or a neural network.

The example system 600 includes at least one processing unit (central processing unit (CPU) or processor) 610 and a connection 605 that couples various system components including system memory 615, such as read-only memory (ROM) 620 and random access memory (RAM) 625 to processor 610. The computing system 600 can include a cache of high-speed memory 612 connected directly with, in close proximity to, or integrated as part of the processor 610.

The processor 610 can include any general-purpose processor and a hardware service or software service, such as services 632, 634, and 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric. In some examples, a service 632, 634, 636 is a shelter perception module, and is configured to identify roadside shelters and save roadside shelter information in a database. The shelter perception module can include a machine learning model for identifying roadside shelters based on perceived features.

To enable user interaction, the computing system 600 includes an input device 645, which can represent any number of input mechanisms, such as a microphone for speech, a touch-sensitive screen for gesture or graphical input, keyboard, mouse, motion input, speech, etc. The computing system 600 can also include an output device 635, which can be one or more of a number of output mechanisms known to those of skill in the art. In some instances, multimodal systems can enable a user to provide multiple types of input/output to communicate with the computing system 600. The computing system 600 can include a communications interface 640, which can generally govern and manage the user input and system output. There is no restriction on operating on any particular hardware arrangement, and therefore the basic features here may easily be substituted for improved hardware or firmware arrangements as they are developed.

A storage device 630 can be a non-volatile memory device and can be a hard disk or other types of computer-readable media which can store data that are accessible by a computer, such as magnetic cassettes, flash memory cards, solid state memory devices, digital versatile disks, cartridges, RAMs, ROMs, and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as a processor 610, a connection 605, an output device 635, etc., to carry out the function.

In various implementations, the routing coordinator is a remote server or a distributed computing system connected to the autonomous vehicles via an Internet connection. In some implementations, the routing coordinator is any suitable computing system. In some examples, the routing coordinator is a collection of autonomous vehicle computers working as a distributed system.

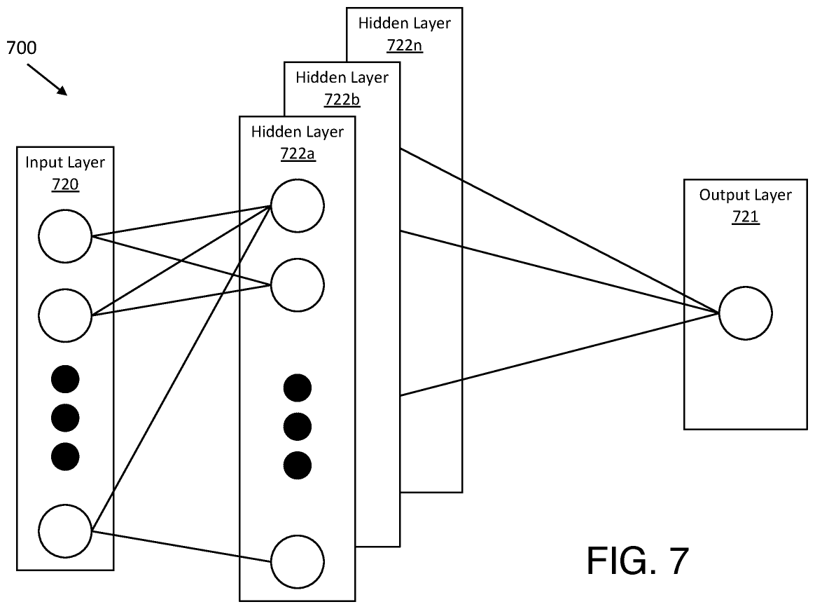

In FIG. 7, the disclosure now turns to a further discussion of models that can be used through the environments and techniques described herein. Specifically, FIG. 7 is an illustrative example of a deep learning neural network 700 that can be used to implement all or a portion of a perception module (or perception system) as discussed above. An input layer 720 can be configured to receive sensor data and/or data relating to an environment surrounding an autonomous vehicle, including roadside features. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 721 that provides an output resulting from the processing performed by the hidden layers 722a, 722b, through 722n. In one illustrative example, the output layer 721 can provide various shelter parameters, that can be used/ingested by a differential simulator to estimate a shelter rating. In some examples, shelter parameters can include the type of element to provide protection from, the size of the shelter, the amount of enclosure, the type of enclosure, the presence of seating, etc.

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as

$$E\_total = \sum ( \frac{1}{2} {( target - output )}^{2} ) .$$

The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Select Examples

Example 1 provides a method for vehicle perception of roadside shelters, comprising: perceiving a roadside feature using vehicle sensors; inputting the roadside feature to a shelter perception module; determining, at the shelter perception module, that the roadside feature is a shelter; identifying, at the shelter perception module, a shelter type for the shelter; determining a shelter location; and recording the shelter type and the shelter location in a shelter mapping database.

Example 2 provides a method, system, and/or vehicle according to one or more of the preceding and/or following examples, further comprising determining there is a passenger inside the vehicle; determining the vehicle is within a selected distance of a drop-off location, wherein the drop-off location is based on an input location; and transmitting to the passenger an option to change the drop-off location from the input location to the shelter location.

Example 3 provides a method, system, and/or vehicle according to one or more of the preceding and/or following examples, further comprising receiving from the passenger a request to change the drop-off location to the shelter location; and stopping at the shelter location.

Example 4 provides a method, system, and/or vehicle according to one or more of the preceding and/or following examples, further comprising, at the drop-off location: sensing, using vehicle sensors, drop-off location conditions, wherein the drop-off location conditions include at least one of lighting conditions, crowdedness, cleanliness, and noisiness.

Example 5 provides a method, system, and/or vehicle according to one or more of the preceding and/or following examples, further comprising adjusting the drop-off location based on the sensed drop-off location conditions.

Example 6 provides a method, system, and/or vehicle according to one or more of the preceding and/or following examples, further comprising determining current environmental conditions, and determining whether the shelter provides protection from the current environmental conditions

Example 7 provides a method, system, and/or vehicle according to one or more of the preceding and/or following examples, further comprising wherein identifying a shelter type includes identifying at least one of a shelter size, a shelter depth, shelter proximity to a curb, degree of shelter enclosure, direction of enclosure opening, and presence of seating.

Example 8 provides a method, system, and/or vehicle according to one or more of the preceding and/or following examples, wherein perceiving a roadside feature using vehicle sensors includes perceiving the roadside feature using at least one of vehicle image sensors, vehicle LIDAR, and vehicle RADAR.

Example 9 provides a vehicle for roadside shelter perception, comprising: a sensor suite including external vehicle sensors to sense a vehicle environment including roadside features and generate sensor data; an onboard computer to receive map data and drive the vehicle along a route; and a shelter perception module to: receive the sensor data including the roadside features, identify roadside shelters based on the roadside features, determine a shelter type for each identified shelter, determine a shelter location for each identified shelter based on the map data, and record, for each identified shelter, the shelter type and the shelter location in a shelter mapping database.

Example 10 provides a method, system, and/or vehicle according to one or more of the preceding and/or following examples, wherein the onboard computer is further to determine there is a passenger inside the vehicle, and determine the vehicle is within a selected distance of a drop-off location, wherein the drop-off location is based on an input location; and wherein the shelter perception module is further to identify a first shelter having a first shelter location within a selected distance of the drop-off location, and transmit to the passenger an option to change the drop-off location from the input location to the first shelter location.

Example 11 provides a method, system, and/or vehicle according to one or more of the preceding and/or following examples, wherein the onboard computer is further to receive from the passenger a request to change the drop-off location to the first shelter location; and to stop the vehicle at the first shelter location.

Example 12 provides a method, system, and/or vehicle according to one or more of the preceding and/or following examples, wherein the shelter perception module is further to determine, based on received sensor data, drop-off location conditions, wherein the drop-off location conditions include at least one of lighting conditions, crowdedness, and noisiness.

Example 13 provides a method, system, and/or vehicle according to one or more of the preceding and/or following examples, wherein the onboard computer is further to receive the drop-off location conditions from the roadside perception module, and adjust the drop-off location based on the drop-off location conditions.

Example 14 provides a method, system, and/or vehicle according to one or more of the preceding and/or following examples, wherein the roadside perception module is further to determine current environmental conditions and determine whether the first shelter provides protection from the current environmental conditions.

Example 15 provides a method for providing a sheltered location for vehicle access, comprising: receiving from a ridehail application a vehicle request at a ridehail service, wherein the vehicle request includes a pick-up location, and a drop-off location; identifying, using a shelter mapping database, at least one shelter having a shelter location within a selected distance of at least one of the pick-up location and the drop-off location; transmitting, to the ridehail application, an option to update at least one of the pick-up location and the drop-off location to the shelter location; receiving, from the ridehail application, a selection to update at least one of the pick-up location and the drop-off location; and updating the vehicle request based on the selection.

Example 16 provides a method, system, and/or vehicle according to one or more of the preceding and/or following examples, wherein the pick-up location is a delivery pick-up location and wherein the drop-off location is a delivery drop-off location.

Example 17 provides a method, system, and/or vehicle according to one or more of the preceding and/or following examples, further comprising identifying a shelter type including at least one shelter characteristic, and wherein transmitting the option includes transmitting the shelter type and the at least one shelter characteristic.

Example 18 provides a method, system, and/or vehicle according to one or more of the preceding and/or following examples, further comprising determining current environmental conditions, and determining whether the shelter provides protection from the current environmental conditions.

Example 19 provides a method, system, and/or vehicle according to one or more of the preceding and/or following examples, wherein transmitting the option includes presenting, via the ridehail application, a map showing the shelter location and at least one of the pick-up location and the drop-off location.

Example 20 provides a method, system, and/or vehicle according to one or more of the preceding and/or following examples, wherein transmitting the option further comprises displaying, on the map, directions from at least one of the pick-up location and the drop-off location to the shelter location.

Example 21 provides a method, system, and/or vehicle according to one or more of the preceding and/or following examples, wherein the shelter type is one of a natural shelter and a manmade shelter.

Example 22 provides a method, system, and/or vehicle according to one or more of the preceding and/or following examples, wherein the vehicle sensors include microphones.

Example 23 provides a method, system, and/or vehicle according to one or more of the preceding and/or following examples, further comprising receiving a ride request including a pick-up location and a drop-off location.

Example 24 provides a method, system, and/or vehicle according to one or more of the preceding and/or following examples, further comprising receiving a delivery request including a delivery pick-up location and a delivery drop-off location.

Example 25 provides a method, system, and/or vehicle according to one or more of the preceding and/or following examples, further comprising a ridehail application configured to receive a ride request including a pick-up location and a drop-off location.

Example 26 provides a method, system, and/or vehicle according to one or more of the preceding and/or following examples, further comprising a personal vehicle application configured to receive a ride request including a pick-up location and a drop-off location.

Example 27 provides a method, system, and/or vehicle according to one or more of the preceding and/or following examples, further comprising a delivery service application configured to receive a delivery request including a delivery pick-up location and a delivery drop-off location.

Example 28 provides a method, system, and/or vehicle according to one or more of the preceding and/or following examples, further comprising a routing coordinator configured to route the vehicle to the pick-up location, and/or from the pick-up location to the drop-off location.

Example 28 provides a method, system, and/or vehicle according to one or more of the preceding and/or following examples, further comprising identifying, based on shelter data from the shelter mapping database, a pick-up location shelter within a selected distance of a pick-up location.

Example 29 provides a method, system, and/or vehicle according to one or more of the preceding and/or following examples, further comprising transmitting to the passenger an option to change the pick-up location from an input location to the pick-up shelter location.

Example 30 provides a method, system, and/or vehicle according to one or more of the preceding and/or following examples, wherein the shelter perception module is a machine learning module.

Example 31 provides a method, system, and/or vehicle according to one or more of the preceding and/or following examples, wherein the shelter perception module is an artificial intelligence module trained to identify roadside shelters.

Example 32 provides a method, system, and/or vehicle according to one or more of the preceding and/or following examples, wherein the shelter perception module is neural network trained to identify roadside shelters.

Example 33 provides a method, system, and/or vehicle according to one or more of the preceding and/or following examples, wherein the shelter perception module is an artificial intelligence component trained to identify roadside shelters.

Example 34 provides a method, system, and/or vehicle according to one or more of the preceding and/or following examples, wherein the shelter perception module is an shelter perception computing component trained to identify roadside shelters.

The various embodiments described above are provided byway of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A method for vehicle perception of roadside shelters, comprising:
perceiving a roadside feature using vehicle sensors;
inputting the roadside feature to a shelter perception module;
determining, at the shelter perception module, that the roadside feature is a shelter;
identifying, at the shelter perception module, a shelter type for the shelter;
determining a shelter location; and
recording the shelter type and the shelter location in a shelter mapping database.

2. The method of claim 1, further comprising:
determining there is a passenger inside the vehicle;
determining the vehicle is within a selected distance of a drop-off location, wherein the drop-off location is based on an input location; and
transmitting to the passenger an option to change the drop-off location from the input location to the shelter location.

3. The method of claim 2, further comprising:
receiving from the passenger a request to change the drop-off location to the shelter location; and
stopping at the shelter location.

4. The method of claim 2, further comprising, at the drop-off location:
sensing, using vehicle sensors, drop-off location conditions, wherein the drop-off location conditions include at least one of lighting conditions, crowdedness, cleanliness, and noisiness.

5. The method of claim 4, further comprising adjusting the drop-off location based on the sensed drop-off location conditions.

6. The method of claim 2, further comprising determining current environmental conditions, and determining whether the shelter provides protection from the current environmental conditions.

7. The method of claim 1, wherein identifying a shelter type includes identifying at least one of a shelter size, a shelter depth, shelter proximity to a curb, degree of shelter enclosure, direction of enclosure opening, and presence of seating.

8. The method of claim 1, wherein perceiving a roadside feature using vehicle sensors includes perceiving the roadside feature using at least one of vehicle image sensors, vehicle LIDAR, and vehicle RADAR.

9. A vehicle for roadside shelter perception, comprising:
a sensor suite including external vehicle sensors to sense a vehicle environment including roadside features and generate sensor data;
an onboard computer to receive map data and drive the vehicle along a route; and
a shelter perception module to:
receive the sensor data including the roadside features,
identify roadside shelters based on the roadside features,
determine a shelter type for each identified shelter,
determine a shelter location for each identified shelter based on the map data, and
record, for each identified shelter, the shelter type and the shelter location in a shelter mapping database.

10. The vehicle of claim 9, wherein the onboard computer is further configured to determine there is a passenger inside the vehicle, and determine the vehicle is within a selected distance of a drop-off location, wherein the drop-off location is based on an input location; and
wherein the shelter perception module is further configured to identify a first shelter having a first shelter location within a selected distance of the drop-off location, and transmit to the passenger an option to change the drop-off location from the input location to the first shelter location.

11. The vehicle of claim 10, wherein the onboard computer is further configured to receive from the passenger a request to change the drop-off location to the first shelter location; and to stop the vehicle at the first shelter location.

12. The vehicle of claim 10, wherein the shelter perception module is further configured to determine, based on received sensor data, drop-off location conditions, wherein the drop-off location conditions include at least one of lighting conditions, crowdedness, and noisiness.

13. The vehicle of claim 12, wherein the onboard computer is further configured to receive the drop-off location conditions from the roadside perception module, and adjust the drop-off location based on the drop-off location conditions.

14. The vehicle of claim 10, wherein the roadside perception module is further configured to determine current environmental conditions and determine whether the first shelter provides protection from the current environmental conditions.

15. A method for providing a sheltered location for vehicle access, comprising:
receiving from a ridehail application a vehicle request at a ridehail service, wherein the vehicle request includes a pick-up location, and a drop-off location;
identifying, using a shelter mapping database, at least one shelter having a shelter location within a selected distance of at least one of the pick-up location and the drop-off location;
transmitting, to the ridehail application, an option to update at least one of the pick-up location and the drop-off location to the shelter location;
receiving, from the ridehail application, a selection to update at least one of the pick-up location and the drop-off location; and
updating the vehicle request based on the selection.

16. The method of claim 15, wherein the pick-up location is a delivery pick-up location and wherein the drop-off location is a delivery drop-off location.

17. The method of claim 15, further comprising identifying a shelter type including at least one shelter characteristic, and wherein transmitting the option includes transmitting the shelter type and the at least one shelter characteristic.

18. The method of claim 17, further comprising determining current environmental conditions, and determining whether the shelter provides protection from the current environmental conditions.

19. The method of claim 15, wherein transmitting the option includes presenting, via the ridehail application, a map showing the shelter location and at least one of the pick-up location and the drop-off location.

20. The method of claim 19, wherein transmitting the option further comprises displaying, on the map, directions from at least one of the pick-up location and the drop-off location to the shelter location.
